(19) United States
(12) Patent Application Publication
(10) Pub. No.: US 2026/0207978 A1
(43) Pub. Date: Jul. 23, 2026

(54) Field Replaceable Personal Self-Retracting Lifeline (SRL) Components

(71) Applicant: Alexander Andrew, Inc., Compton, CA (US)

(72) Inventors: John F. Aldrich, Solvang, CA (US); Martin R. Sevilla, Rancho Santa Margarita, CA (US)

(21) Appl. No.: 18/831,886

(22) Filed: Oct. 27, 2025

Related U.S. Application Data
(60) Provisional application No. 63/721,531, filed on Nov. 17, 2024.

(51) Int. Cl. A62B 35/00

(52) U.S. Cl. CPC A62B 35/0037; A62B 35/0093

(57) ABSTRACT

A system includes a first connecting component. A second connecting component is attached to the first connecting component. A first field replaceable self-retracting lifeline (SRL) is connected to a first attaching component that is connected to the second connecting component. The first connecting component includes a rod configured for attaching to webbing of a fall protection harness, and the first field replaceable SRL is replaceable with a second field replaceable SRL without recertification.

### CROSS-REFERENCE TO RELATED APPLICATIONS

This application claims the priority benefit of U.S. Provisional Patent Application Ser. No. 63/721,531, filed on Nov. 17, 2024, which is incorporated herein by reference in its entirety.

### BACKGROUND

### Field

The embodiments relate to self-retracting lifelines/lanyards (SRLs) for fall protection, and in particular to field replaceable SRLs that are replaceable without recertification.

### Description of the Related Art

Personal SRLs are used in fall protection by attachment to a fall protection harness. The leading causation for death in the construction industry is a fall event. When workers are working at a level higher than six feet, they are at a higher risk of injury or death. Personal fall protection/arrest systems, equipped with SRLs, help prevent falls and injury.

An SRL is a vertical fall protection device that provides for a user to move around and maintains consistent tautness for preventing fall events. The SRL pulls out and retracts easily. In a fall event or sudden movement, an internal braking mechanism engages, and stops a fall. The SRL functions normally again once the tension releases. During a fall event, the SRL's internal braking system disperses the energy of the fall over a short distance, which limits the force applied to a user's body.

Inspections of SRLs can usually be conducted on site, but after a fall event an SRL that has been subjected to a load exceeding normal usage must be recertified and/or repaired, which occurs at a factory authorized repair center. In the event of a fall, a locking mechanism inside an SRL engages and the fall is arrested, typically within three feet, reducing the actual fall distance and the likelihood of a swing fall. Maintenance is required and these devices need a regular inspection schedule. Compliance is a factor as well. Occupational Safety and Health Administration (OSHA) requires that fall protection equipment be inspected prior to each use. Annual inspections must also take place.

Inspections can reveal damage that is indicative of the need for recertification. Physical damage to an SRL casing might not render a unit inoperable, but is still cause for removal from service and recertification by the manufacturer. A frayed or broken cable is a common occurrence for units that have been under heavy use, and is also an indication of the need for servicing. An obvious indicator for recertification occurs when a load indicator has been activated, such as a built-in load indicator. When an SRL is subject to a load with enough energy to activate the indicator, a typical SRL is removed from service immediately and sent to the manufacturer for recertification.

Recertification is the assurance that an SRL continues to meet strict safety and performance standards. Recertification periods are self-determined by the owner. Manufacturers recommend a specific schedule (e.g.,2 years, 3 years, etc.).

### SUMMARY

Some embodiments relate to field replaceable self-retracting lifelines/lanyards (SRLs) that are replaceable without recertification. One embodiment provides a system that includes a first connecting component. A second connecting component is attached to the first connecting component. A first field replaceable self-retracting lifeline (SRL) is connected to a first attaching component that is connected to the second connecting component. The first connecting component includes a rod configured for attaching to webbing of a fall protection harness, and the first field replaceable SRL is replaceable with a second field replaceable SRL without recertification.

Another embodiment provides a first coupling component. A second coupling component is coupled to the first coupling component. A first field replaceable SRL is coupled to a first connecting component that is coupled to the second coupling component. A second field replaceable SRL is coupled to a second connecting component that is coupled to the second coupling component. The first coupling component includes a coupling rod configured for attaching to webbing of a fall protection harness. The first field replaceable SRL and the second field replaceable SRL are each replaceable with another field replaceable SRL without recertification.

Still another embodiment provides a method for replacing a field replaceable SRL without recertification. The method includes removing, using a first tool, a set connector from a holding portion of a locking device coupled with a first attachment component of a first field replaceable SRL. The method further includes at least partially removing the locking device away from a connecting component via a through-hole by releasing the locking device using a second tool. The method additionally includes removing the first attachment component from the connecting component that frees the first replaceable SRL. Still further, the method includes aligning a second attachment component of a second field replaceable SRL with the connecting component. The method further includes inserting the locking device into the through-hole and connecting the locking device to the connecting component using the second tool. Additionally, the method includes installing, using the first tool, the set connect and engaging the set connector to the holding portion of the locking device, wherein the second field replaceable SRL replaces the first field replaceable SRL without recertification.

### BRIEF DESCRIPTION OF THE DRAWINGS

FIG. 1 shows a system with field replaceable self-retracting lifeline/lanyard (SRL) connecting components shown with cover(s) removed from the SRLs, according to some embodiments;

FIG. 2 shows a conventional SRL system attached to a fall protection harness;

FIGS. 3-6 show conventional examples of non-field-replaceable SRL systems;

FIG. 7 shows conventional twin SRLs permanently connected to a single energy absorber;

FIG. 8 shows conventional twin SRLs with an single energy absorber near each connecting hook;

FIGS. 9A-B show a specialized tool required to slide holding pins in or out of a field replaceable SRL connector, according to some embodiments;

FIG. 10 shows a system with an isolated view of the field replaceable SRL connecting components shown with cover(s) removed from the SRLs, according to some embodiments; and

FIG. 11 shows alternative connecting hardware for coupling to the SRL connecting components, according to some embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some embodiments relate to field replaceable self-retracting lifelines/lanyards (SRLs) that are replaceable without recertification. One embodiment provides a system that includes a first connecting component. A second connecting component is attached to the first connecting component. A first field replaceable self-retracting lifeline (SRL) is connected to a first attaching component that is connected to the second connecting component. The first connecting. component includes a rod configured for attaching to webbing of a fall protection harness, and the first field replaceable SRL is replaceable with a second field replaceable SRL without recertification.

Another embodiment provides a system that includes a first coupling component. A second coupling component is coupled to the first coupling component. A first field replaceable SRL is coupled to a first connecting component that is coupled to the second coupling component. A second field replaceable SRL is coupled to a second connecting component that is coupled to the second coupling component. The first coupling component includes a coupling rod configured for attaching to webbing of a fall protection harness. The first field replaceable SRL and the second field replaceable SRL are each replaceable with another field replaceable SRL without recertification.

Still another embodiment provides a method for replacing a field replaceable SRL without recertification. The method includes removing, using a first tool, a set connector from a holding portion of a locking device coupled with a first attachment component of a first field replaceable SRL. The method further includes at least partially removing the locking device away from a connecting component via a through-hole by releasing the locking device using a second tool. The method additionally includes removing the first attachment component from the connecting component that frees the first replaceable SRL. Still further, the method includes aligning a second attachment component of a second field replaceable SRL with the connecting component. The method further includes inserting the locking device into the through-hole and connecting the locking device to the connecting component using the second tool. Additionally, the method includes installing, using the first tool, the set connect and engaging the set connector to the holding portion of the locking device, wherein the second field replaceable SRL replaces the first field replaceable SRL without recertification.

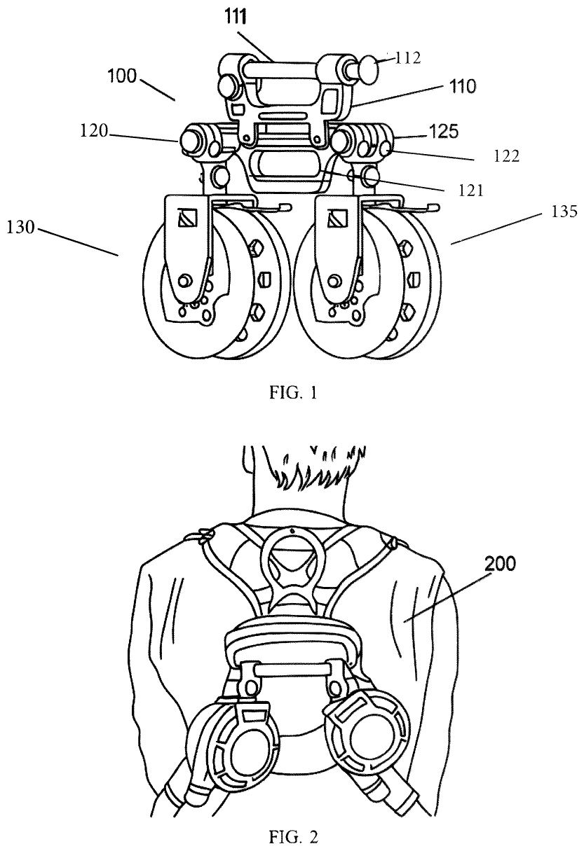

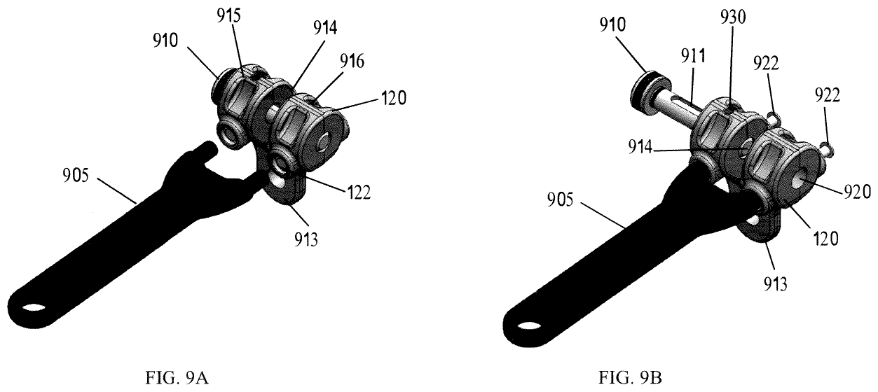

FIG. 1 shows a system 100 with field replaceable SRL connecting components 120/125 shown with cover(s) removed from the SRLs 130/135, according to some embodiments. An upper coupling component 110 includes a coupling rod 111 and locking component 112. The coupling rod 111 attaches to webbing of a fall protection harness. The lower coupling component 121 includes coupling through-holes for attaching the connecting components 120 and 125 with a rod or locking device/component (pin, bolt, etc.) 910 (FIG. 9B). The connecting components 120 and 125 include pin openings 122 for pins 922 (FIG. 9B). The connecting components 120 and 125, upper coupling component 110, and lower coupling component 121 are made of metal or metal alloy. In some embodiments, the upper coupling component 110 is permanently fixed or integrated with the lower coupling component 121. In other embodiments, the upper coupling component 110 is removably connected to the lower coupling component 121.

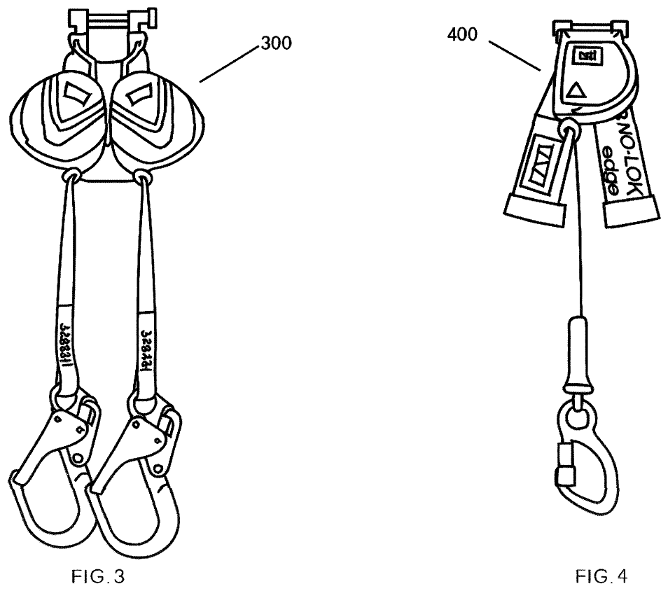

FIG. 2 shows a conventional SRL system 200 attached to a fall protection harness.

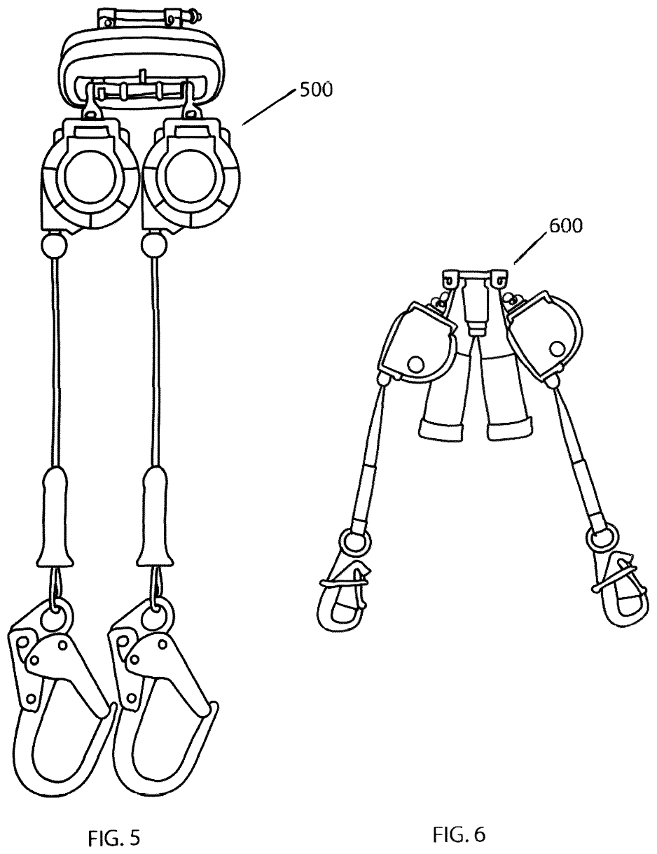

FIGS. 3-6 show conventional examples of non-field-replaceable SRL systems. FIG. 3 shows conventional leading edge web lifeline system 300. FIG. 4 shows conventional leading edge cable lifeline system 400. FIG. 5 shows a conventional dual SRL leading edge cable lifeline system 500. FIG. 6 shows a conventional tie-back web lifeline dual SRL system 600. All of these may be configured in a single or dual SRL system.

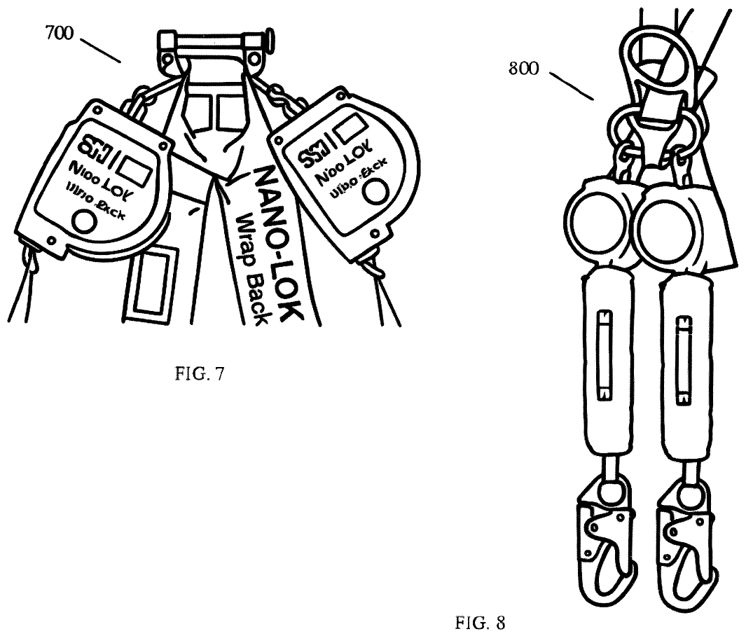

FIG. 7 shows a conventional twin SRL system 700 that is permanently connected to a single energy absorber. FIG. 8 shows a conventional twin SRL system 800 with a single energy absorber near each connecting hook. Some personal SRLs have energy absorbers near the hook of each SRL. The SRLs can be replaced individually if they wear out, but in applications in which the user can fall over an edge, the energy absorber must be located at the end that attaches to the user's fall protection harness to control fall arrest forces on the user. Therefore, these devices cannot be used in those applications. For these applications, conventional personal SRL systems consist of one or two SRL units permanently connected to a single energy absorber that attaches to the user's harness. The issue with these devices is that if either SRL wears out or is damaged, the entire assembly must be removed from service. Common reasons for removal from service include: web lifeline worn/frayed, cable lifeline damaged from welding arc, labels worn out/illegible, etc.

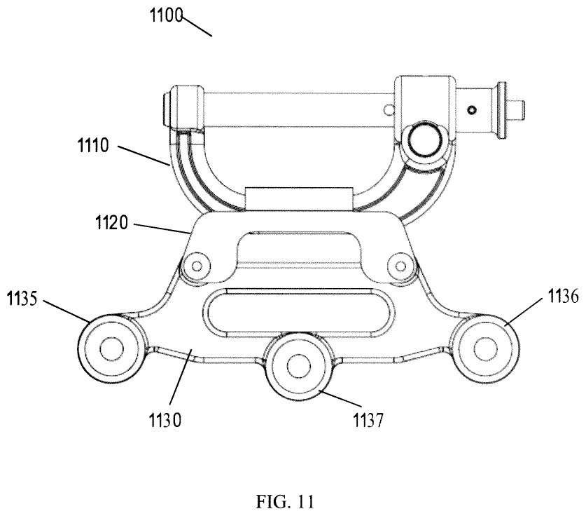

FIGS. 9A-B show a specialized tool 905 required to engage or slide the pins 922 in or out for opening or closing a field replaceable SRL connector 120, according to some embodiments. As shown, the field replaceable SRL connector 120 includes a first portion 915 and a second portion 916 with a spacing 914 (for access of the rod 910 to be placed through a connector portion of the lower coupling component 121, similar to connector portions 1135, 1136 and 1137, FIG. 11) for sliding on to a connecting portion on the ends of the lower coupling component 121 that includes a through-hole for sliding a rod 910 through a through-hole 920 in each of the first portion 915 and the second portion 916. The rod 910 includes a portion that receives a set or holding connector 930 (e.g., is pressed against, includes a threaded portion to receive the set or holding connector, etc., where the set or holding connector is a screw, bolt, pin, etc.). In some embodiments, the pins 922 are recessed to minimize risk of unintentional disengagement. The slot/groove/channel 911 engages with pins 922 for opening or closing the field replaceable SRL connector 120 on the lower portion of the rod 910. In operation, a safety manager would have control over who has access to the specialized tool 905. In some embodiments, the pins 922 are recessed from the pin openings 122 at where the specialized tool 905 is inserted to prevent accidental force being applied to the pins 922 for safety.

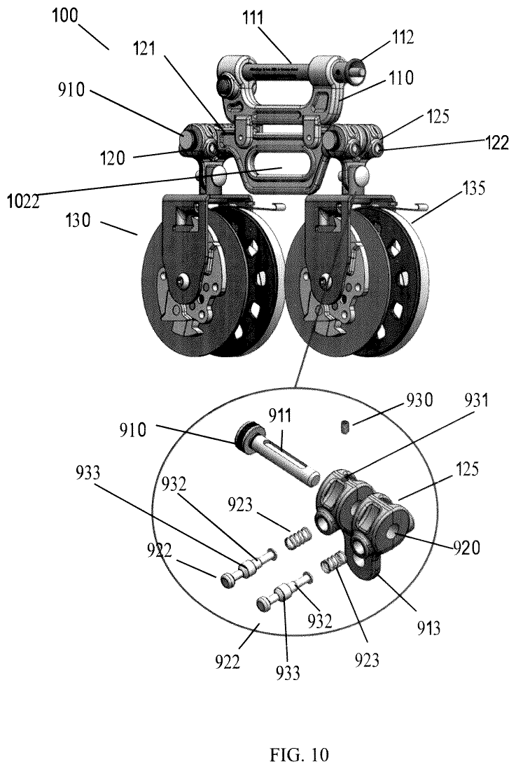

FIG. 10 shows a system with an isolated view of the field replaceable SRL connecting components 120 and 125 shown with cover(s) removed from the SRLs 130 and 135, according to some embodiments. As shown, the pins 922 include an inner rod portion that has a larger diameter locking portion 932 that engages the slot 911 and use springs 923 to lock in (or open and close) the field replaceable SRL connecting components 120 and 125 using the specialized tool 905 (FIGS. 9A-B). In one embodiment, upon applying a force to an outer end of the pins 922, the locking portion 932 is moved within the housing portion 933. The smaller radius inner portion of the pins 922 provides for moving the rod 910 such that the slot 911 provides for sliding the rod 910 to release the field replaceable SRL connecting component 120 or 125 from the through-hole connector portion of the lower coupling component 121. In another embodiments, upon a force being applied to the exterior end of the pins 922 through the pin openings 122, the pins 922 exit the other end of the pin openings 122releasing engagement with the rod 910 providing for the rod 910 to slide outwards and clear of the through-hole connector portion of the lower coupling component 121 (see, e.g., the through-holes of a first connector portion 1135, a second connecting portion 1136 and a middle connecting portion 1137, FIG. 11). In some embodiments, the lower coupling component 121 includes an opening 1022 for connecting with other devices, such as an energy absorber. In some embodiments, the field replaceable SRL feature using the field replaceable SRL connecting components 120 and 125 are connectable to one or two SRL's permanently attached to an energy absorber assembly. If one of the SRLs is damaged, the entire device must be removed from service. With conventional systems, some manufacturers will replace an individual SRL, but that repair must be conducted at a repair facility. Distinguishable, with one or more embodiments, if an SRL is damaged during use, the end-user can replace the individual SRL in the field in a matter of minutes using the specialized tool 905. In other embodiments, the system 100 may have alternative hardware configurations for the SRL connecting components 120 and 125 where the pin openings 122 for pins 922 are removed, and the rod 910 is a keyed bolt, threaded bolt, etc. that still includes a portion for the set or holding connector 930 (e.g., screw, etc.).

In some embodiments, a method of replacing one or more of the replaceable SRLs 130 or 135 includes the following. An authorized person, such as a safety manager, etc. would remove the set or holding connector 930 (e.g., screw, etc.) using an appropriate driver tool (e.g., screwdriver, etc.) or Allen/hex/torx, etc. wrench/key etc. from the slot/groove/channel 911 by accessing the set or holding connector 930 (e.g., screw, etc.) from the opening 931. Next, in one or more embodiments, the rod 910 or equivalent hardware must be removed from the through-hole 920. In some embodiments, when the rod 910 is employed, the pins 922 must be removed to release the rod 910 as the slot/groove/channel 911 engages with pins 922 on the lower portion of the rod 910. In one or more embodiments, the specialized tool 905 is utilized by inserting the two ends into the pin openings 122 and applying force to push the pins 922 away from the slot/groove/channel 911 of the rod 910, which releases the rod 910 so that it may slide outwards from the through-hole 920. In some other embodiments utilizing alternative hardware configurations for the SRL connecting components 120 and 125 where the pin openings 122 for pins 922 are removed and unnecessary, and the rod 910 is a bolt, keyed bolt, threaded (on the end portion) bolt, etc. that also includes the portion for a set or holding connector 930 (e.g., screw, etc.), where a tool may be used such as a Allen/hex/torx wrench/driver/key, ratchet driver (e.g., specialized fit, polygonal shaped, security shape (i.e., customized shape or one of a kind shape, etc.) for removal of the rod from 910. Next the replaceable SRL 130 or 135 is removed and replaced in the opposite order with another field replaceable SRL 130 or 135, etc.

FIG. 11 shows alternative connecting hardware 1100 for coupling to the SRL connecting components 120 and 125, according to some embodiments. The connecting hardware 1100 includes an upper coupling component 1110, a saddle connector 1120 that couples with a lower SRL coupling component 1130. The lower SRL coupling component 1130 includes three connector portions, including a first connector portion 1135, a second connecting portion 1136 and a middle connecting portion 1137. The first connecting portion 1135 and the second connecting portion 1136 connect to the SRL connecting components 120 and 125 (FIG. 10). The saddle connector 1120 saddles over the lower portion of the upper coupling component 1110 and is removable from the upper coupling component. The lower portion of the saddle connector 1120 attaches to the lower SRL coupling component 1130 using connectors (e.g., pins, bolts, etc.) through through-holes on either side of the lower portion of the saddle connector 1120 and through-holes on either side of an upper portion of the lower SRL coupling component 1130. In some embodiments, the first connector portion 1135, the second connecting portion 1136 and the middle connecting portion 1137 may each be connected to a field replaceable SRL such as field replaceable SRL 130/135, etc.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system comprising:
a first coupling component;
a second coupling component coupled to the first coupling component; and
a first field replaceable self-retracting lifeline (SRL) coupled to a first connecting component that is coupled to the second coupling component;
wherein the first coupling component includes a coupling rod configured for attaching to webbing of a fall protection harness, and the first field replaceable SRL is replaceable with a second field replaceable SRL without recertification.

2. The system of claim 1, wherein the first field replaceable SRL includes a first attachment component that couples the first field replaceable SRL to the first connecting component.

3. The system of claim 1, wherein a first locking device connects the first connecting component to the second coupling component.

4. The system of claim 3, wherein the first locking device is removable from a first through-hole in the first connecting component via a drive tool.

5. The system of claim 4, wherein the first locking device is threaded into the first connecting component.

6. The system of claim 4, wherein the first locking device comprises a slot, and a first pin and a second pin each removably couple with the slot to engage the first locking device.

7. The system of claim 6, wherein the first connecting component includes a second through-hole and a third through-hole, the first pin is disposed within the second through-hole and the second pin is disposed within the third through-hole.

8. The system of claim 7, wherein a specialized tool is configured for entering both the second through-hole and the third-through-hole simultaneously to remove engagement of the first pin and the second pin from the first locking device.

9. The system of claim 1, further comprising:
a third field replaceable SRL coupled to a second connecting component that is coupled to the second coupling component;
wherein the third field replaceable SRL is replaceable with a fourth field replaceable SRL without recertification, and the second coupling component includes an opening for connecting with an energy absorber device.

10. A system comprising:
a first coupling component;
a second coupling component coupled to the first coupling component;
a first field replaceable self-retracting lifeline (SRL) coupled to a first connecting component that is coupled to the second coupling component; and
a second field replaceable SRL coupled to a second connecting component that is coupled to the second coupling component
wherein the first coupling component includes a coupling rod configured for attaching to webbing of a fall protection harness, and the first field replaceable SRL and the second field replaceable SRL are each replaceable with another field replaceable SRL without recertification.

11. The system of claim 10, wherein:
the first field replaceable SRL includes a first attachment component that couples the first field replaceable SRL to the first connecting component; and
the second field replaceable SRL includes a second attachment component that couples the second field replaceable SRL to the second connecting component.

12. The system of claim 10, wherein:
a first locking device connects the first connecting component to the second coupling component; and
a second locking device connects the second connecting component to the second coupling component

13. The system of claim 12, wherein:
the first locking device is removable from a first through-hole in the first connecting component via a drive tool; and
the second locking device is removable from a second through-hole in the second connecting component via the drive tool

14. The system of claim 13, wherein:
the first locking device is threaded into the first connecting component; and
the second locking device is threaded into the second connecting component.

15. The system of claim 13, wherein:
the first locking device comprises a first slot, and a first pin and a second pin each removably couple with the first slot to engage the first locking device; and
the second locking device comprises a second slot, and a third pin and a fourth pin each removably couple with the second slot to engage the second locking device

16. The system of claim 15, wherein:
the first connecting component includes a third through-hole and a fourth through-hole, the first pin is disposed within the third through-hole and the second pin is disposed within the fourth through-hole; and
the second connecting component includes a fifth through-hole and a sixth through-hole, the third pin is disposed within the fifth through-hole and the fourth pin is disposed within the sixth through-hole.

17. The system of claim 16, wherein:
a specialized tool is configured for entering both the third through-hole and the fourth-through-hole simultaneously to remove engagement of the first pin and the second pin from the first locking device; and
the specialized tool is configured for entering both the fifth through-hole and the sixth-through-hole simultaneously to remove engagement of the third pin and the fourth pin from the second locking device.

18. The system of claim 10, wherein the second coupling component includes an opening for connecting with an energy absorber device.

19. A method for replacing a field replaceable self-retracting lifeline (SRL) without recertification, comprising:
removing, using a first tool, a set connector from a holding portion of a locking device coupled with a first attachment component of a first field replaceable SRL;
at least partially removing the locking device away from a connecting component via a through-hole by releasing the locking device using a second tool;
removing the first attachment component from the connecting component that frees the first replaceable SRL;
aligning a second attachment component of a second field replaceable SRL with the connecting component;
inserting the locking device into the through-hole and connecting the locking device to the connecting component using the second tool; and
installing, using the first tool, the set connect and engaging the set connector to the holding portion of the locking device,
wherein the second field replaceable SRL replaces the first field replaceable SRL without recertification.

20. The method of claim 19, wherein the locking device removed by unthreading the locking device or disengaging one or more pins from a slot within the locking device.
